(19) United States
(12) Patent Application Publication
(10) Pub. No.: US 2009/0238513 A1
(43) Pub. Date: Sep. 24, 2009

(54) WDM-Based Sensor System And Sensor Interrogation System

(76) Inventors: Jianzhong Hao, Singapore (SG); Shiro Takahashi, Mito-City (JP); Zhaohui Cai, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/300,029

(22) PCT Filed: May 8, 2007
(86) PCT No.: PCT/SG07/00129

§ 371 Date: Apr. 9, 2009

Related U.S. Application Data
(60) Provisional application No. 60/799,038, filed on May 9, 2006.

(51) Int. Cl. G02B 6/10

(52) U.S. Cl. 385/12

(57) ABSTRACT

A WDM based sensor system, a method of interrogating a plurality of sensor elements, and a WDM based sensor interrogation system. The WDM based sensor system comprises a WDM MUX/DEMUX element for demultiplexing an optical input signal into a plurality of substantially non-overlapping signals in respective sensing channels; one or more sensor elements disposed in each sensing channel; wherein the MUX/DEMUX element multiplexes sensing signals from the respective sensing channels into an optical return signal; and a detector element for detecting the sensing signals in the multiplexed optical return signal.

### FIELD OF INVENTION

The present invention relates broadly to a WDM-based sensor system, a method of interrogating a sensor system, and a WDM-based sensor interrogation system.

### BACKGROUND

Sensor systems are getting more and more important in advanced society. With in sensor systems, optical sensor systems are interesting to be developed, especially under Electro Magnetic Interference (EMI) conditions such as applications in healthcare and civil engineering fields, or under hazardous conditions (e.g. application in chemical and biological industries). However the main issues to be addressed in optical sensor systems are cost and reliability.

Fiber Bragg Grating (FBG) sensors are one of the most reliable and sensitive optical sensors for field applications. They have shown great potential for a wide range of applications where quasi-distributed measurement of strain, temperature, pressure, acceleration, magnetic field and force are required. This is due to the small size and robustness, ease of fabrication, and suitability for use in multiplexed sensor networks and smart structures of FBG sensors.

In order to reduce the system cost per sensor, there exist multiplexing technologies, which allow many sensors to share the interrogation system cost. Multiplexing is important from an economical viewpoint because optical components, such as broadband light sources, tuning components, optical amplifiers, optical switches and detecting devices are very expensive. In order to make a cost-effective system, it is typically necessary to share the optical components by using multiplexing techniques.

Arrayed Waveguide Gratings (AWGS) are currently being used as optical multiplexers or demultiplexers in Wavelength Division Multiplexed (WDM) systems. These devices are capable of multiplexing or demultiplexing a large number of wavelengths into a single optical fiber, thereby increasing the transmission capacity of optical networks considerably. A generic AWG 100 is shown in FIG. 1. Other multiplexing techniques include spatial-division-multiplexing (SDM), time-division-multiplexing (TDM), and their combinations.

Existing FBG sensor techniques can generally be divided into two types—Serial sensing or Parallel sensing. One WDM based serial sensing technique is shown in FIG. 2, where wavelength scanning FBG sensor, e.g. 200, interrogation using a tuneable filter 202 and a broadband light source 204 are implemented. Scanning free interrogation techniques have also been proposed using a AWG 300 and PD array 302 as shown in FIG. 3. Here, the AWG 300 functions as a wavelength demultiplexer to split the reflected signal from a series of cascaded FBG sensors e.g. 304 into respective channels, thus utilizing the AWG 300 demultiplexer for a scanning free detection method.

The limitations in using serial sensing techniques include:
Two pigtails for each FBG sensor are necessary to form a cascaded sensor network, which increases the module size due to the of input and output pigtails; and
Interference or disturbance in between cascaded FBG sensors in a same fiber due to:
   Spectrum overlapping among sensors. To overcome this, wider wavelength separation is required in between sensors, which result in limited number of sensors.
   Peak splitting, which restricts the dynamic sensing range.
   Operation dependency—any sensor breakdown can affect the normal operation of subsequent sensors along the same fiber. Hence protection of fibers and sensor modules become crucial to prevent breakdown damage. This also implies the replacement difficulties for maintenance.

To achieve parallel FBG sensing, optical power splitters or couplers have been used to split one channel into multiple channels (SDM). However, each channel shares the same bandwidth hence needs its own photodetector (PD) to detect the sensor signal. Furthermore, the light intensity of each channel is reduced due to the loss introduced by power splitters. On the other hand, parallel FBG sensing has been proposed using optical switches to time-switch one channel into multiple channels (TDM). However, like in SDM, each channel shares the same bandwidth and hence needs its own PD to detect the sensor signal.

Furthermore, both SDM and TDM require additional optical components to be used. For example, in Yun-Jiang Rao and David Jackson, “Recent progress in multiplexing techniques for in-fibre Bragg grating sensors”, SPIE Vol. 2895, pp 171-182. 1996, and Rao, Y. J.; Ribeiro, A. B. L.; Jackson, D. A.; Zhang, L.; Bennion, I, “Multi-point in-fibre grating strain sensing system with a combined spatial and time division multiplexing scheme”, Progress in Fibre Optic Sensors and Their Applications, IEE Colloquium on 7 Nov. 1995 Page(s):8/1-8/5, a combination scheme of SDM and TDM for multi-point FBG strain sensing (parallel sensing) is described, in which the return pulse signals from the FBG sensors are coupled back into the splitter and detected by an array of four avalanche photodetectors (APD) with integral high-speed amplifiers. The signals from the APD array are selected by a switch. Thus, each APD receives the returned signals from two FBG's separated in time by about 400 ns. These two signals are separated by two high speed switches controlled by the delayed electric pulses produced by a pulse generator. On the other hand, the phase information contained in the interference signal is recovered by a pseudo-heterodyne technique described in D. A. Jackson, A. D. Kersey, and M. Corke, Electron. Lett. 18, 1081, (1982). Such complicated processes, however, result in an increase in cost. Other disadvantages includes: each channel for SDM receives less power and this leads to poor Signal to Noise ratio, which eventually limits the number of channels/sensors that the system can support.

For existing WDM technology used for serial sensor systems, there is a severe disadvantage of signal dependency, because each sensor in the same fiber/channel can affect other sensors' operation in the event that a) one sensor is damaged and needs to be replaced, or b) one sensor runs out of range hence the Bragg wavelength of that sensor over-writes adjacent sensors, which results in error readings. To prevent this from happening, each adjacent sensor must have enough wavelength separation, which in turn limits the number of sensors that each fiber can hold.

Independent sensor networks are important, especially in the field of healthcare applications, e.g. when the sensors are e.g. not installed permanently, i.e. constantly being attached or detached to an object in order to detect the information of individuals. For independent sensor networks, SDM and TDM can be applied but the previous serial WDM techniques cannot be used. Therefore, it is currently expensive to realize independent sensor networks.

A need therefore exists to provide a WDM based sensor system which seeks to address at least one of the above disadvantages.

### SUMMARY

In accordance with a first aspect of the present invention, there is provided a WDM based sensor system comprising a WDM MUX/DEMUX element for demultiplexing an optical input signal into a plurality of substantially non-overlapping signals in respective sensing channels; one or more sensor elements disposed in each sensing channel; wherein the MUX/DEMUX element multiplexes sensing signals from the respective sensing channels into an optical return signal; and a detector element for detecting the sensing signals in the multiplexed optical return signal.

The MUX/DEMUX element may comprise an Arrayed Waveguide Grating (AWG) or a Thin Film Filter (TFF).

The sensor system may further comprise a light source for generating the optical input signal.

The light source may comprise a broadband light source, and the sensor system further may comprise a tuneable filter element disposed between the MUX/DEMUX element and the detector element for tuneably filtering the multiplexed optical return signal for detecting the respective sensing signals.

The light source may comprise a broadband light source, and the sensor system further may comprise a tuneable filter element disposed between the broadband light source and the MUX/DEMUX element for tuneably filtering an emission signal from the broadband light source, and the MUX/DEMUX element wavelength dependently directs the filtered emission signal from the broadband light source into the respective sensing channels for interrogating the sensor elements.

The light source may comprise a swept laser, and the MUX/DEMUX element wavelength dependently directs the emission signal from the swept laser into the respective sensing channels for interrogating the sensor elements.

The light source may comprise a tuneable laser source, and the MUX/DEMUX element wavelength dependently directs the emission signal from the tuneable laser source into the respective sensing channels for interrogating the sensor elements.

The broadband light source may comprise a Superluminescent Light Emitting Diode (SLED) or an Amplified Spontaneous Emission (ASE) light source.

The sensor elements may comprise Fibre Bragg Gratings (FBGs) or Tunable Etalons.

The detector element may comprise a Photo Diode (PD).

The sensor system may further comprise a Time Division Multiplexing (TDM) element incorporated into an optical path for applying TDM techniques to one or more of the sensing channels.

The sensor system may further comprise a Spatial Division Multiplexing (SDM) element incorporated into an optical path for applying SDM techniques to one or more of the sensing channels.

In accordance with a second aspect of the present invention, there is provided a method of interrogating a plurality of sensor elements, the method comprising the steps of demultiplexing an optical input signal into a plurality of substantially non-overlapping signals in respective sensing channels utilising a WDM MUX/DEMUX element, wherein the one or more of the sensor elements are disposed in each sensing channel; multiplexing sensing signals from the respective sensing channels into an optical return signal utilising the MUX/DEMUX element; and detecting the sensing signals in the multiplexed optical return signal.

In accordance with a third aspect of the present invention, there is provided a WDM based sensor interrogation system comprising a WDM MUX/DEMUX element for demultiplexing an optical input signal into a plurality of substantially non-overlapping signals in respective sensing channels; wherein the MUX/DEMUX element multiplexes sensing signals from the respective sensing channels into an optical return signal; and a detector element for detecting the sensing signals in the multiplexed optical return signal.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing of a generic AWG de-multiplexer;

FIG. 2 shows a schematic drawing of a serial WDM FBG sensor system;

FIG. 3 shows a schematic drawing of FBG interrogation using an AWG and PD array as a scanning free detector;

FIG. 4a) shows a schematic drawing of a WDM-based FBG sensor system according to an example embodiment;

FIG. 4b) shows a schematic drawing of a WDM-based Tunable Etalon sensor system according to an example embodiment;

FIG. 5 shows a schematic drawing of a WDM-based FBG sensor system according to another configuration in other example embodimens;

FIG. 6 shows a schematic drawing of a WDM-based FBG sensor system test set-up illustrating implementation of an example embodiment;

FIG. 7 shows a schematic drawing of the WDM-based FBG sensor system test set-up of FIG. 6 in other test configuration;

FIG. 7 shows a schematic drawing of the WDM-based FBG sensor system test set-up of FIG. 6 in other test configuration;

FIG. 8 shows a schematic drawing of the WDM-based FBG sensor system test set-up of FIG. 6 in other test configuration;

FIG. 9 shows a schematic drawing of the WDM-based FBG sensor system test set-up of FIG. 6 in other test configuration;

FIG. 10 shows a schematic drawing of the WDM-based FBG sensor system test set-up of FIG. 6 in other test configuration;

FIG. 11 shows a schematic drawing of the WDM-based FBG sensor system test set-up of FIG. 6 in other test configuration;

FIG. 12 shows a schematic drawing of the WDM-based FBG sensor system test set-up of FIG. 6 in other test configuration;

FIG. 13 shows a schematic drawing of an example system implementation of a WDM-based FBG sensor system according to an example embodiment, in a health care environment application.

FIG. 14 shows a flowchart illustrating a method of interrogating a plurality of sensor elements according to an example embodiment.

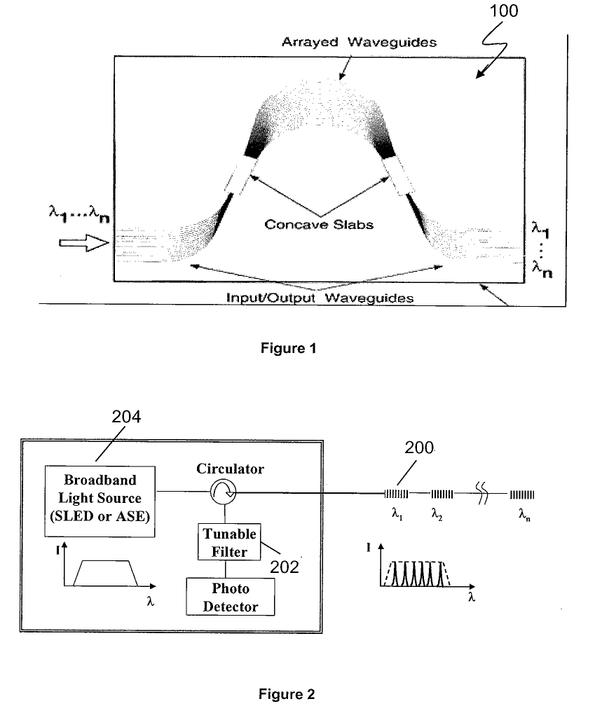

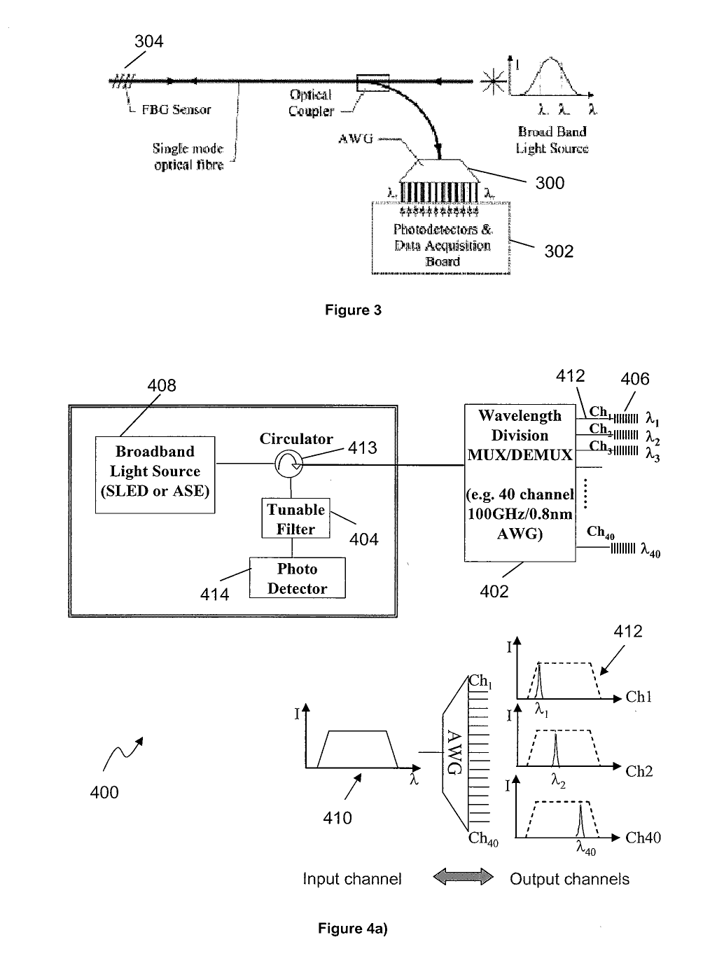

### DETAILED DESCRIPTION

The example embodiments described provide systems relating to WDM-based, independent FBG sensor systems, for use in applications where FBG sensors are required to work independently and simultaneously. The example embodiments use a modified WDM technique for the independent sensor network system composed of a general interrogation system and an optical wavelength MUX/DEMUX component.

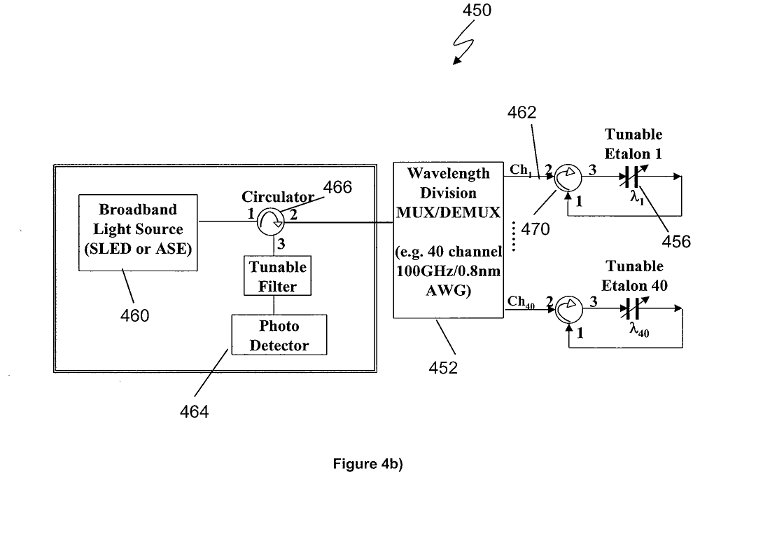

FIG. 4a) shows a schematic drawing of a WDM-based FBG sensor system 400 in one embodiment, using a MUX/DEMUX (multiplexer/demultiplexer), here an Arrayed Waveguide Grating (AWG) 402 or a Thin Film Filter (TFF) which supports many parallel terminal-type FBG sensors e.g. 406 to work simultaneously but independently for various sensing applications. For instance, applications include to monitor various vital signs of patients in a hospital, such as body temperature, pulse rate and respiration frequency. All the sensors e.g. 406 in the system 400 work simultaneously but each of them works independently within its own optical spectrum without interrupting each other.

In the system 400, the AWG 402 performs wavelength slicing of the broadband light source 408 signal, realizing demultiplexing from one channel 410 (the input channel) into many non-overlapping narrow bandwidth channels e.g. 412 (the output channels), and multiplexing of reflected signals from the multiple channels e.g. 412 into one channel 410.

In other words, in the system 400, each channel e.g. 412 covers a different wavelengths band. The wavelength slicing by the AWG 402 of the broadband light source 408 signal on its path towards the FBG sensors e.g. 406 creates the non-overlapping channels e.g. 412 for respective FBG sensors e.g. 406. It will be appreciated that the FBG sensors 406 are chosen such that their reflection characteristics fall within the wavelength band of the respective channels e.g. 412 during the intended sensing operation. However, advantageously, the multiplexing performed by the AWG 402 of the reflected signals from the FBG sensors e.g. 406 via the circulator 413 and the tunable filter 404 towards the photodetector 414 ensures that, should for some reason, such as a mal-functioning or out-off range operation, the reflected signal fall outside the associated channel e.g. 412, then such a reflected signal is prevented from progressing towards the photodetector 414. It will be “rejected” at the AWG 402. Therefore, the system 400 advantageously provides independent, parallel sensing in which cross-over of the sensing signal from one channel into the others is prevented, thus ensuring a reliable sensing operation. In this embodiment, the tunable filter 404 is used to selectively detect the sensing signals from the respective channels e.g. 412 using a single photodetector 414.

FIG. 4b) shows a schematic drawing of a WDM-based sensor system 450 in another embodiment, using a MUX/DEMUX (multiplexer/demultiplexer), here an Arrayed Waveguide Grating (AWG) 452 or a Thin Film Filter (TFF) which supports many parallel Fabry-Perot interferometers, also known as tunable Etalon sensors e.g. 456 to work simultaneously but independently for various sensing applications. All the sensors e.g. 456 in the system 450 work simultaneously but each of them works independently within its own optical spectrum without interrupting each other.

Like in system 400 (FIG. 4a), the AWG 452 performs wavelength slicing of the broadband light, source 460 signal, realizing demultiplexing from one channel (the input channel) into many non-overlapping narrow bandwidth channels e.g. 462 (the output channels), and multiplexing of reflected signals from the multiple channels e.g. 462 into one channel, for detection at the photodetector 464, via the circulator 466 and the tunable filter 468.

Compared to the embodiment described above with reference to FIG. 4a), because the tunable Etalon sensors e.g. 456 function as band-pass filters, only the transmitted signals can be detected. Hence, circulators e.g. 470 are inserted in front of each tunable Etalon sensor e.g. 456 in each sensing channel e.g. 462, so that the demultiplexed signal from each AWG 452 channel will launch into the tunable Etalon sensors e.g. 456 from the port 2 to the port 3 of the circulators e.g. 470, i.e. after passing through the tunable Etalon sensors e.g. 456, the transmitted signal can be coupled back to the circulators e.g. 470 (from port 1 and port 2), and returned to the AWG 452 for further processing. This configuration provides a complete isolation of any unwanted reflected signal from the tunable Etalon sensors e.g. 456 since the signal from the port 3 of the circulators e.g. 470 is totally isolated from the port 1 of the circulators e.g. 470, hence gives the sensing signal of such a tunable Etalon sensor e.g. 456 a very high signal-to-noise ratio. Compared to the embodiment described above with reference to FIG. 4a), the system 450 is expected to have a slightly higher system cost due to the additional circulators e.g. 470 used for each channel e.g. 462.

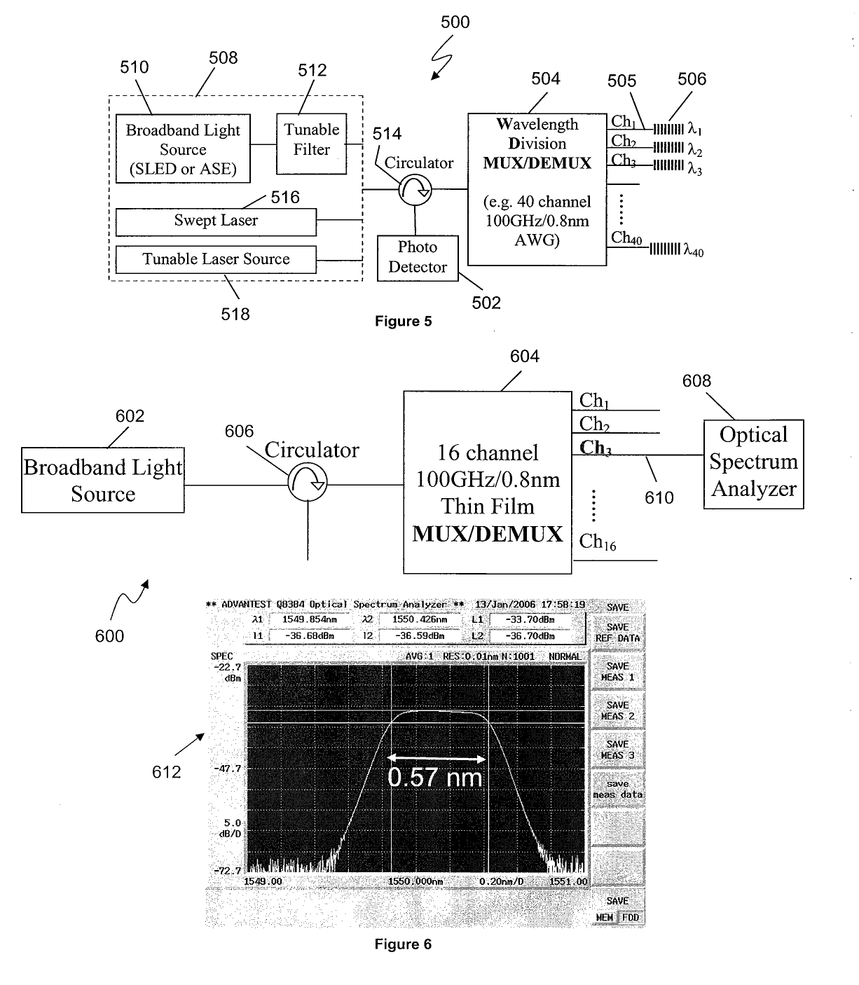

FIG. 5 shows a schematic drawing of a sensor system 500 according to embodiments in which no tuneable filter is utilised at the photodetector 502. Similar to the embodiment described above with reference to FIG. 4, a MUX/DEMUX component, here a AWG 504, performs wavelength slicing from one channel (the input channel) into many non-overlapping narrow bandwidth channels (the output channel), and multiplexing of reflected signals from the multiple channels into one channel. FBG sensors e.g. 506 are provided in the respective channels for parallel sensing. In the configuration shown in FIG. 5, different alternatives for creating the input channel signals from a source, generally indicated at box 508, are illustrated. More particular, in one alternative, a broadband light source 510 (such as a Superluminescent Light Emitting Diode (SLED) or Amplified Spontaneous Emission (ASE) source) passes through an optical tuneable filter 512. The tuneable filter 512 sweeps the light with a given scanning frequency. In other alternatives, the combination of broadband light source 510 and tuneable filter 512 can be replaced by a swept laser 516 or a tuneable laser source 518. The circulator 514 directs the light signal from source 508 into the AWG 504, which separates several closely spaced wavelengths into respective multiple output channels e.g. 505 with channel spacing. Each channel is connected to one or more FBG sensors e.g. 506 and the reflected light from each sensor channel is multiplexed in the AWG 504 and then directed to the photodetector 502 by the circulator 514.

Again, each sensor channel e.g. 505 is fully independent from any other channel, i.e. each sensor channel e.g. 505 can work standalone within its own optical spectrum determined by the AWG 504 without disturbing any other channels. Even in the case that the reflected signal of the sensor is out of its AWG channel spectrum, the signal will only disappear temporarily but it will never override to adjacent channels.

FIG. 6 shows a schematic drawing of an experimental test-set up 600 for illustrating implementation examples and characteristics of the example embodiments described above. In the test set-up 600, a broadband light source 602 provides the input channel optical signal, which is directed towards a 16 channel 100 GHz/0.8 nm thin film MUX/DEMUX component, here an AWG 604, via a circulator 606.

An optical spectrum analyser 608 is connected to one of the channels 610. The insert 612 in FIG. 6 shows the measured spectrum at channel 610, illustrating an output channel with a full width at half maximum (FWHM) of about 0.57 nm.

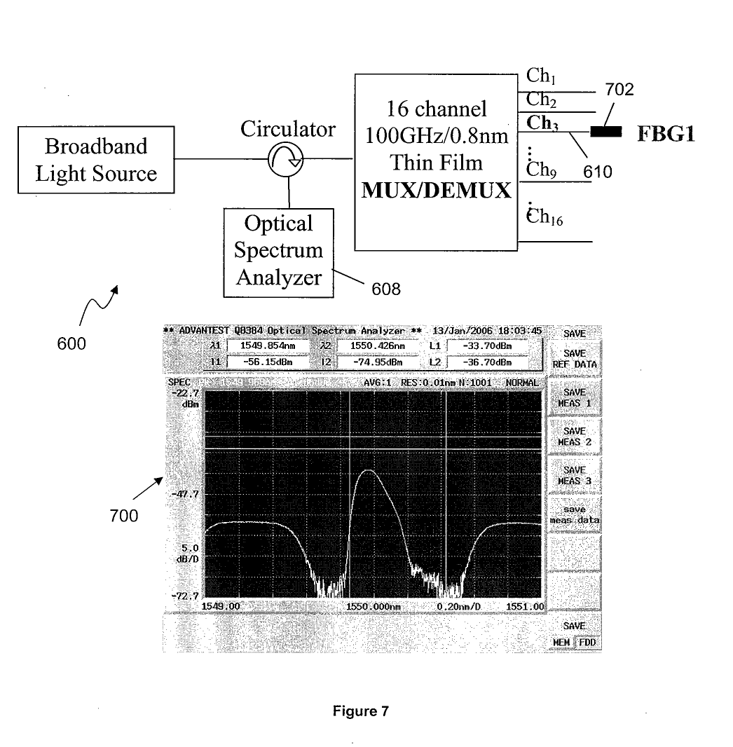

Next, FIG. 7 shows a schematic drawing of the experimental test-setup 600, where the optical spectrum analyser 608 is now connected to an output of the circulator 606. A FBG sensor 702 is now connected to channel 610. Insert 700 shows the corresponding reflected signal in the wavelength band of the output channel 610, indicated by the channel FWHM cross bars. Here, the FBG 702 is in an unstrained condition. The measured FWHM of the FBG 700 is about 0.2 nm.

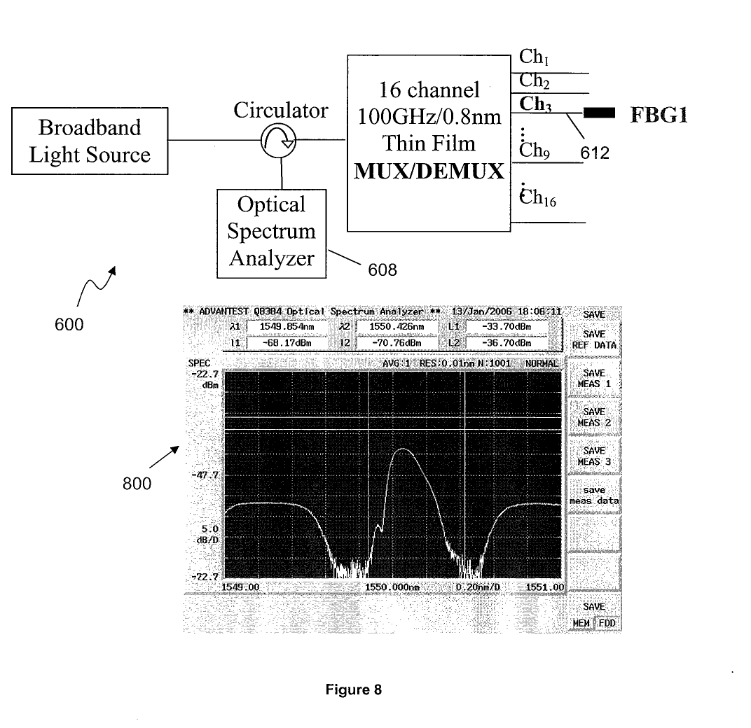

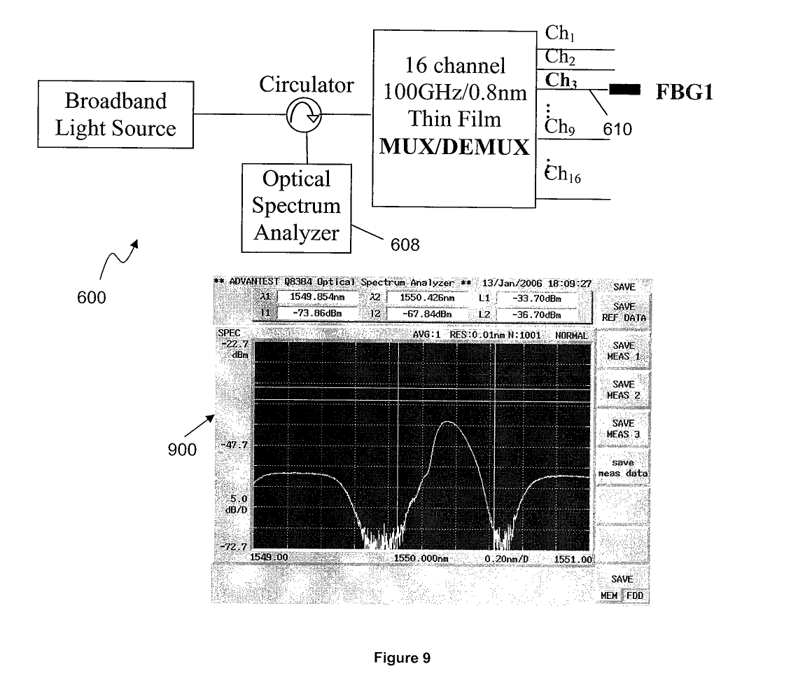

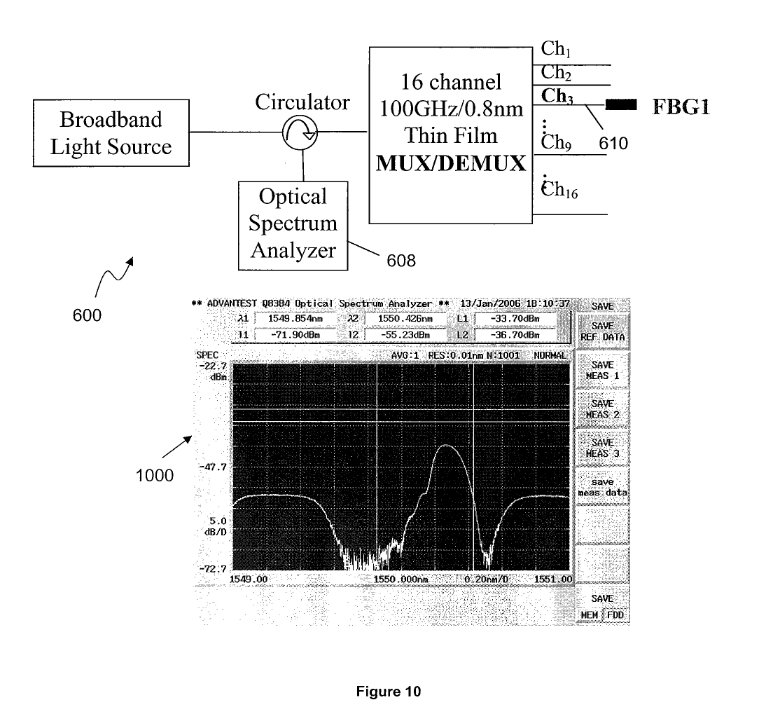

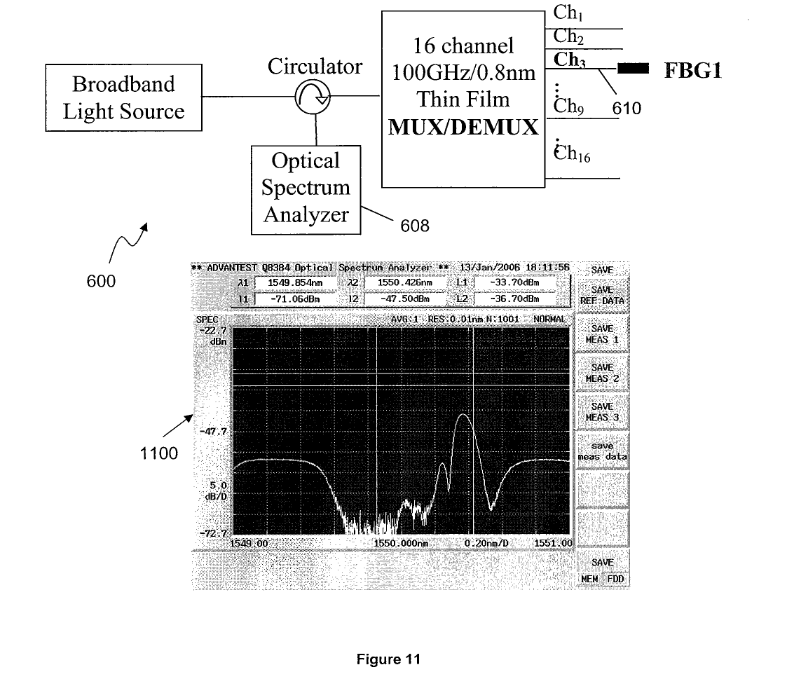

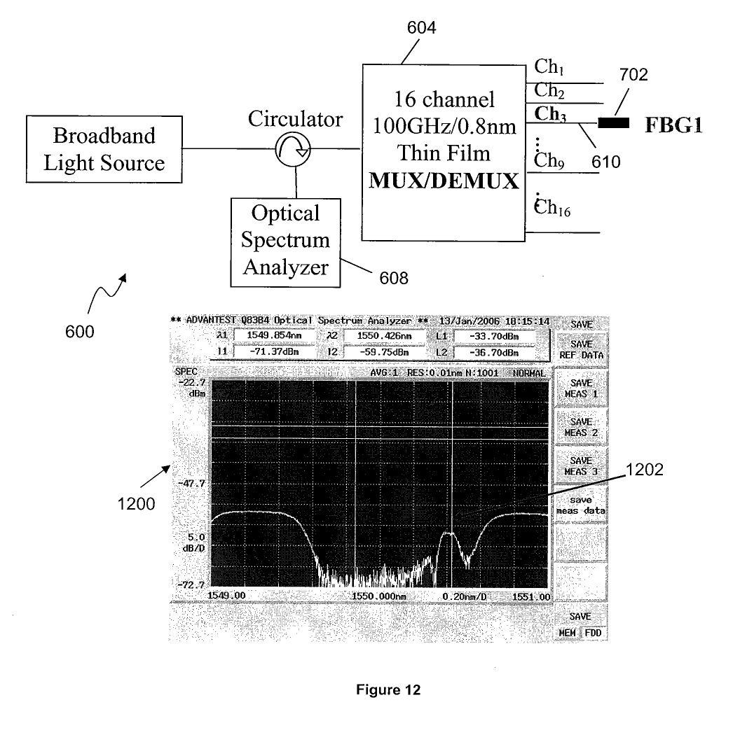

FIGS. 8 to 12 show schematic drawings of the experimental test set-up 600 and, in the respective inserts, the measured signal within the wavelength band of channel 610, for different strain conditions of the FBG 700. As can be seen from FIGS. 8 to 12, the peak position of the FBG reflected signal changes for the different stress conditions, thus illustrating independent sensing within the channel 610. Furthermore, with reference to FIG. 12, it can be seen that as the peak reflection wavelength of the FBG 700 moves towards the boundary and beyond the wavelength band of channel 610, as determined by the MUX/DEMUX 604, the FBG signal 1200 is diminished and disappears. This clearly illustrates that fully independent sensing channels can be implemented, i.e. an out-of-range signal from one of the channels is prevented from “interfering” with any of the other channels by way of the multiplexing operation of the MUX/DEMUX 604.

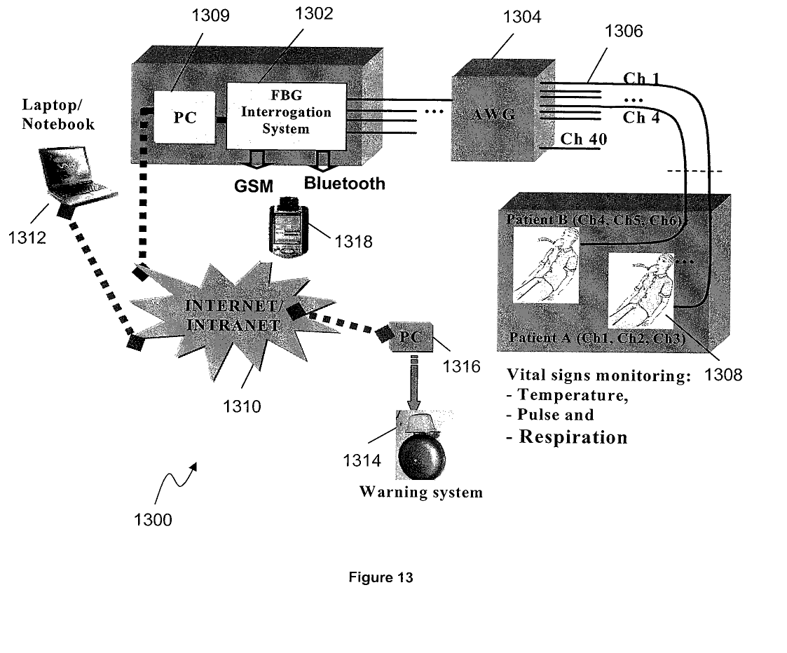

FIG. 13 shows a schematic drawing of an example system implementation for vital-sign monitoring in a health care environment application. The system 1300 comprises a FBG interrogation system 1302 coupled to one or more AWG modules 1304. FBG sensors in respective channels e.g. 1306 are used for vital-sign monitoring of individual patients e.g. 1308. As will be appreciated, the configuration of the FBG interrogation system 1302, AWGs 1302, and channels e.g. 1306 with FBG sensors is as described above for the different example embodiments. A personal computer system 1309 is coupled to the FBG interrogation system 1302, for interconnection to a network 1310 for sharing the monitoring data with other terminals such as laptop/notebook 1312, and/or for coupling to warning systems e.g. 1314 via another personal computer system 1316.

Furthermore, the FBG interrogation system 1302 incorporates in this example implementation wireless interface capabilities such as Global System for Mobile communication (GSM) or Bluetooth, for interfacing with other peripheral devices such as handheld devices 1318. Vital signs monitoring of basic physiological parameters such as body temperature, pulse rate, respiration rate, etc. of ill and frail individuals residing within a health care facility such as an acute care hospital, community hospital, nursing home, and chronic sick unit forms one of the many possible applications of example embodiments of the present invention.

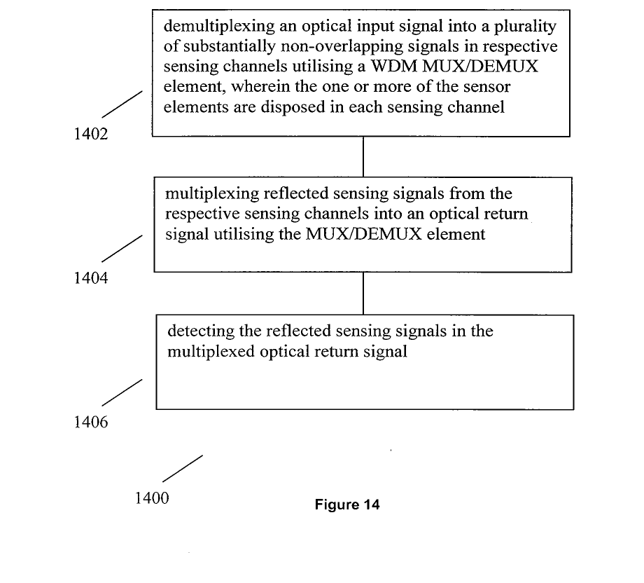

FIG. 14 shows a flowchart 1400 illustrating a method of interrogating a plurality of sensor elements according to an example embodiment. At step 1402 an optical input signal is demultiplexed into a plurality of substantially non-overlapping signals in respective sensing channels utilising a WDM MUX/DEMUX element, wherein the one or more of the sensor elements are disposed in each sensing channel. At step 1404, reflected sensing signals from the respective sensing channels are multiplexed into an optical return signal utilising the MUX/DEMUX element. At step 1406, the reflected sensing signals are detected in the multiplexed optical return signal.

Using the described WDM independent sensor system (for instance, by deploying a 100 GHz AWG or a 50 GHz AWG), one can realise an independent sensor system made up of 100 channels or 200 channels, if the light source bandwidth is 80 nm and the dynamic range of each sensor is 0.8 nm or 0.4 nm. It will be appreciated that SDM and TDM can be combined with/incorporated into embodiments of the present invention.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1: A WDM based sensor system comprising:
a WDM MUX/DEMUX element for demultiplexing an optical input signal into a plurality of substantially non-overlapping signals in respective sensing channels;
one or more sensor elements disposed in each sensing channel;
wherein the MUX/DEMUX element multiplexes sensing signals from the respective sensing channels into an optical return signal; and
a detector element for detecting the sensing signals in the multiplexed optical return signal.

2: The sensor system as claimed in claim 1, wherein the MUX/DEMUX element comprises an Arrayed Waveguide Grating (AWG) or a Thin Film Filter (TFF).

3: The sensor system as claimed in claim 1, further comprising a light source for generating the optical input signal.

4: The sensor system as claimed in claim 3, wherein the light source comprises a broadband light source, and the sensor system further comprises a tuneable filter element disposed between the MUX/DEMUX element and the detector element for tuneably filtering the multiplexed optical return signal for detecting the respective sensing signals.

5: The sensor system as claimed in claim 3, wherein the light source comprises a broadband light source, and the sensor system further comprises a tuneable filter element disposed between the broadband light source and the MUX/DEMUX element for tuneably filtering an emission signal from the broadband light source, and the MUX/DEMUX element wavelength dependency directs the filtered emission signal from the broadband light source into the respective sensing channels for interrogating the sensor elements.

6: The sensor system as claimed in claim 3, wherein the light source comprises a swept laser, and the MUX/DEMUX element wavelength dependently directs the emission signal from the swept laser into the respective sensing channels for interrogating the sensor elements.

7: The sensor system as claimed in claim 3, wherein the light source comprises a tuneable laser source, and the MUX/DEMUX element wavelength dependency directs the emission signal from the tuneable laser source into the respective sensing channels for interrogating the sensor elements.

8: The sensor system as claimed in claim 4, wherein the broadband light source comprises a Superluminescent Light Emitting Diode (SLED) or an Amplified Spontaneous Emission (ASE) light source.

9: The sensor system as claimed in claim 1, wherein the sensor elements comprise Fibre Bragg Gratings (FBGs) or Tunable Etalons.

10: The sensor system as claimed in claim 1, wherein the detector element comprises a Photo Diode (PD).

11: The sensor system as claimed in claim 1, further comprising a Time Division Multiplexing (TDM) element incorporated into an optical path for applying TDM techniques to one or more of the sensing channels.

12: The sensor system as claimed in claim 1, further comprising a Spatial Division Multiplexing (SDM) element incorporated into an optical path for applying SDM techniques to one or more of the sensing channels.

13: A method of interrogating a plurality of sensor elements, the method comprising the steps of:
demultiplexing an optical input signal into a plurality of substantially non-overlapping signals in respective sensing channels utilising a WDM MUX/DEMUX element, wherein the one or more of the sensor elements are disposed in each sensing channel;
multiplexing sensing signals from the respective sensing channels into an optical return signal utilising the MUX/DEMUX element; and
detecting the sensing signals in the multiplexed optical return signal.

14: A WDM based sensor interrogation system comprising:
a WDM MUX/DEMUX element for demultiplexing an optical input signal into a plurality of substantially non-overlapping signals in respective sensing channels;
wherein the MUX/DEMUX element multiplexes sensing signals from the respective sensing channels into an optical return signal; and
a detector element for detecting the sensing signals in the multiplexed optical return signal.
